(19) United States
(12) Patent Application Publication
(10) Pub. No.: US 2022/0150280 A1
(43) Pub. Date: May 12, 2022

(54) CONTEXT MENU SECURITY POLICY ENFORCEMENT

(71) Applicant: Microsoft Technology Licensing, LLC, Redmond, WA (US)

(72) Inventors: Itamar AZULAY, Mishmar Ayyalon (IL); Ishay HILZENRAT, Tel Aviv (IL); Tomer CHERNI, Ganei Tikva (IL)

(21) Appl. No.: 17/091,660

(22) Filed: Nov. 6, 2020

(51) Int. Cl. H04L 29/06; G06F 3/0482; G06F 16/953

(52) U.S. Cl. CPC H04L 63/20; H04L 67/42; G06F 16/953; G06F 3/0482

(57) ABSTRACT

Context menu item operations pose risks to sensitive data, such as confidentiality violations from data exfiltration during “search” or “translate” communications with external sites, as well as “paste”, “delete”, “move” and other context menu item operations that may harm data integrity or data availability even if no external site is involved. Control scripts injected by a security broker or proxy, working with event listeners in a web page, may be used to monitor and control web browser context menu item displays and functionalities based on suggested or mandated context menu policy actions obtained from a policy server. Policy that is specific to context menus is also enforced in other interactive programs that use context menus, thereby protecting sensitive data against both malevolent efforts and innocent mistakes. Protection may be provided for any kind of sensitive data, regardless of the sensitivity designation criteria or mechanism.

### BACKGROUND

Noon Attacks on computing systems take many different forms, including some forms which are difficult to predict, and forms which may vary from one situation to another. Accordingly, one of the guiding principles of cybersecurity is “defense in depth”. In practice, defense in depth is often pursued by forcing attackers to encounter multiple different kinds of security mechanisms at multiple different locations around or within a computing system. No single security mechanism is able to detect every kind of cyberattack, or able to end every detected cyberattack. But sometimes combining and layering a sufficient number and variety of defenses will deter an attacker, or at least limit the scope of harm from an attack.

To implement defense in depth, cybersecurity professionals consider the different kinds of attacks that could be made. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place.

However, because computing systems are often complicated and circumstances unpredictable, it may be very difficult or impractical to foresee every possible attack or threat against a computing system or the data it holds. Accordingly, even incremental advances in cybersecurity can be worthwhile.

### SUMMARY

Some embodiments enforce security policy against particular software functionality which was not previously subject to its own dedicated or specific security policy, namely, software context menu functionality. In some cases, context menu security policy enforcement reduces or prevents exfiltration of sensitive data by previously unmonitored context menu operations such as those that send text to a web search engine or a natural language translation engine. In some situations, policy enforcement bars the display of non-secure context menu options, while in other situations previously unmonitored context menu options are displayed but their operations are modified to enhance the protection of sensitive data. Other context menu security enforcement tools and techniques are also described herein.

Some embodiments use or provide a computing hardware and software combination which includes a digital memory containing sensitive data, and a processor which is in operable communication with the memory. The processor is configured, e.g., by tailored software, to perform steps for context menu security policy enforcement. Such an embodiment may include an interactive program having a user interface, which includes a context menu having at least one context menu item that is configured to access the sensitive data. The context menu security policy enforcement steps may include (a) detecting a triggering of the context menu item, (b) sending a policy query which identifies the triggered context menu item, (c) receiving a policy response to the policy query, and (d) performing a policy action that is specified by the policy response. Performing the policy action may include vetting, modifying, or blocking an operation of the context menu item, thereby protecting the sensitive data by maintaining or enhancing a confidentiality of the sensitive data, an integrity of the sensitive data, or an availability of the sensitive data.

Some embodiments use or provide steps for a context menu security policy enforcement method which aids protection of a sensitive data item. The steps may include: ascertaining a presence of a context menu item in an interactive program; proactively sending, to a policy server, a policy query which identifies the context menu item; receiving, from the policy server, a policy response to the policy query, the policy response specifying a policy action pursuant to a context menu item policy; and performing the policy action by vetting, modifying, or blocking an operation of the context menu item. Thus, the method aids protection of the sensitive data item by enforcing a context menu security policy.

Some embodiments use or provide a computer-readable storage medium configured with data and instructions, or use other computing items, which upon execution by a processor cause a computing system to perform a method for context menu security policy enforcement to aid protection of a sensitive data item. This method includes: ascertaining a presence of a context menu item in an interactive web browser program; proactively sending, to a policy server, a policy query which identifies the context menu item; receiving, from the policy server, a policy response to the policy query, the policy response specifying a policy action; and performing the policy action by vetting, modifying, or blocking an operation of the context menu item in the web browser. IN this manner, the method aids protection of the sensitive data by enforcing a context menu security policy.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating a computing system equipped with context menu security policy enforcement functionality, and some aspects of a surrounding environment;

FIG. 3 is a block diagram illustrating some aspects of an enhanced computing system configured with context menu security policy enforcement functionality and aspects of that system's environment;

FIG. 4 is a block diagram illustrating some examples of context menu item operations that may be subject to context menu security policy enforcement;

FIG. 5 is a block diagram illustrating some examples of sensitive data that may be protected by context menu security policy enforcement;

FIG. 6 is a flowchart illustrating steps in some context menu security policy enforcement methods;

FIG. 7 is a diagram illustrating a computing system display configured with a context menu; and

FIG. 8 is a flowchart further illustrating steps in some context menu security policy enforcement methods.

### DETAILED DESCRIPTION

Overview

Innovations may expand beyond their origins, but understanding an innovation's origins can help one more fully appreciate the innovation. In the present case, some teachings described herein were motivated by technical challenges faced by Microsoft innovators who were working to improve the usability, efficiency, and effectiveness of Microsoft cloud security offerings, including versions of Microsoft cloud app security, e.g., Conditional Access App Control™ security software within Azure® Active Directory® environments (marks of Microsoft Corporation). Teachings herein also apply to other cloud and non-cloud software environments, applications, and tools. In particular, teachings herein may be applied to enforce security against web browser context menus.

The innovators considered implications of the fact that most if not all web browsers now include a context menu feature to conveniently send user-selected text to one or more web search engines. For example, in a web page displayed in the Google Chrome® browser version 86.0.4240.111, Official Build, 64-bit (mark of Google, LLC), a user can double-click a mouse left button to select a word such as “Microsoft” and then with that word highlighted to indicate it is selected, the user can click the right button to display a context menu. The displayed context menu shows the following context menu items:

### Copy Ctrl+C

### Search Secure Search for “Microsoft”

### Print . . . Ctrl+P

### Inspect Ctrl+Shift+I

The context menu item presented to the user as “Search Secure Search for ‘Microsoft’” may be secured in the sense that data will be encrypted when it is transmitted from the web browser to a search engine in response to activation of this context menu item. But activation of the context menu item is non-secure, in the sense that the encrypted data may be sensitive and will be decrypted by the search engine. The search engine will then possess a plaintext copy of the sensitive data, which may subsequently be placed in search engine logs, user search histories, search term collections, and other data structures or locations or records that are not subject to the same data protection policy requirements and security controls the data was subject to within the user's organization before the user transmitted the data to the search engine.

In this particular example, the transmitted text “Microsoft” is unlikely to be sensitive data. But in the absence of policy enforcement as described herein, the same context menu item search functionality will also send other data outside the user's organization, and that other data may well be sensitive. For instance, a user who is not a cybersecurity professional may unintentionally expose sensitive data such as a chemical formula, list of ingredients, manufacturing process step, manufacturing tolerance, health condition, account number, prospective plant location, or other trade secret or personal identifiable information or confidential or proprietary information, simply by invoking a context menu web search to learn more about the topic represented by the sensitive data. Indeed, learning more about the topic may be part of the user's authorized work responsibilities; the question remains of how security innovations can help such users perform their authorized work without unwanted risks to the sensitive information they access.

In view of the foregoing, some embodiments described herein help protect sensitive data by automatically enforcing security policies by modifying one or more operations implicated in context menus. For example, operations that would otherwise have sent sensitive data to an external search engine or to an external translation engine (e.g., for English-Chinese translation) are modified; these operations might not be offered at all to users, or they might filter out or mask likely sensitive data to prevent its transmission. Context menu operations that seek access to sensitive data or have access to sensitive data may also be modified, even if data transmission to an engine outside an organization is not otherwise imminent. Operations such as copying data to a flash drive, or copying between documents, may be restricted.

Moreover, although enhanced protection for data confidentiality is an important aspect of many embodiments, context menu policy enforcement may also help protect data integrity and data availability. For example, a policy's enforcement may prevent use of a context menu to overwrite sensitive data which is labeled as such, or enforcement may prevent use of a context menu to move data from a location that is designated for sensitive data to a location that is designated only for general use. Many other examples will be clear to one of skill in the art from the disclosure provided herein.

Thus, a technical challenge faced by the innovators was to how to automatically and efficiently protect sensitive data in the face of changes to the functionality offered to users of application programs generally, and web browser functionality in particular. One emergent subsidiary challenge was how to monitor context menu operations. Another technical challenge was how to modify context menu operation functionality to protect sensitive data. One of skill will recognize these and other technical challenges as they are addressed at various points within the present disclosure.

Operating Environments

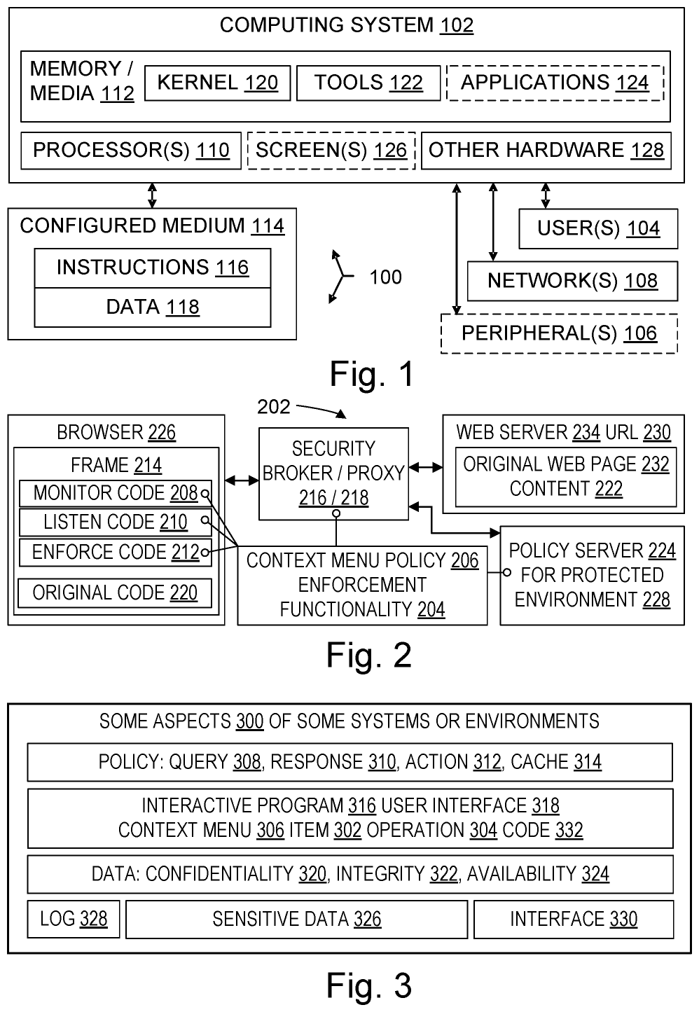

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Storage media 112 may be of different physical types. The storage media 112 may be volatile memory, non-volatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage medium 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud or enterprise network. In particular, functionality for context menu policy enforcement could be installed on an air gapped network and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More about Systems

FIGS. 2, 3, and 7 illustrate an environment having an enhanced system 202, 102 that includes functionality 204 for enforcement of a context menu security policy 206. In some embodiments, the functionality 204 is divided between different machines 102, while on others the functionality 204 resides on a single machine 102.

In particular, FIG. 7 illustrates a stylized display of a system 202 configured with functionality 204. The stylization replaced web page text with line segments, for instance, to better focus on the overall appearance of an example context menu 306 in an example user interface 318.

In the illustrated embodiment, the functionality 204 includes scripts or other software codes to detect software context menu operations 304, or in some embodiments to detect to presence of code for performing such operations. In some embodiments, the functionality 204 includes codes to enforce the policy 206 against those operations 304. As used herein, policy enforcement may include monitoring, or intervention in data operations, or prevention of data operations, or a combination thereof, for example. Detection of context menu item presence or activation, or both, like other enforcement actions, may be memorialized in a log 328 or otherwise audited.

In some embodiments, a monitor code 208 may include a script that is injected into a web frame 214 by a security broker 216 or another proxy 218 in front of the original HTML code 220 of a web page's content 222, after the broker obtains the web page 232 from a web server 234. The injected script may check for “search” or “translate” context menu items 302, for instance. The script or other monitor code 208 may also include or install listen code 210, such as event listeners, which is triggered when a context menu item is activated by user interaction. The script or other monitor code 208 may also include or install proactive enforce code 212, which effectively removes an item 302 from the context menu 306 by barring the item from being displayed to users, or grays out the item for all data, or grays out the item when the data on which the item would operate is deemed sensitive, or masks sensitive data operated on by the item (e.g., by replacing account numbers with X's or asterisks), or proactively takes some other policy enforcement action to protect sensitive data that is (or might be) exposed to a context menu item operation.

In the illustrated system 202, the policy 206 is managed by a policy server 224. The policy server 224 may be on the same machine as the broker 216, or on a different machine. In some embodiments, the policy server 224 is on the same machine as the web browser 226.

In the illustrated system 202, the policy 206 is enforced within a protected environment 228. Presence within the protected environment 228 may be evident, e.g., in a suffix attached to the URL 230 of the web page 232 into which the policy enforcement script was injected. Some Microsoft protected environments, in particular, are denoted by a “.mcas.ms” suffix, e.g., as in “my dot sharepoint dot com dot mcas dot ms” where dot represents a period.

Although FIG. 2 shows monitor code 208, listen code 210, and enforce code 212 as distinct items, one of skill will acknowledge that these three codes may in practice be combined into two pieces of code or even one code which has a combination of monitoring, listening, and enforcing capabilities. An embodiment may also omit some of the capabilities that are present in examples provided herein, e.g., by performing only listening and logging of context menu item activations without revealing the enforcement code's presence to users by visibly preventing completion of a requested search or translate operation 304.

As noted in FIG. 3 and discussed herein, context menu policy enforcement may include a query 308 to the policy server 224 from the injected code, and a corresponding response 310 indicating an optional or mandatory enforcement action 312 to be taken by or on behalf of the injected code. Queries 308, responses 310, and actions 312, or some of the foregoing, may be stored locally on a browser 226 machine or a proxy 218 machine in a cache 314. They may be implemented using objects, XML, packets, or other data structures, and remote procedure call, TCP/IP, or other communication mechanisms.

The web browser 226 is an example of an interactive program 316 which has a user interface 318 that can display a context menu 306. However, a context menu policy 206 could be enforced, e.g., for any kind of program that uses a context menu 306 and supports event detection and control functions to control the program's behavior based on the policy. The context menu policy enforcement teachings herein are not limited to use only within web browsers 226; they may also or instead be used in one or more other interactive programs 316 in a given embodiment. Indeed, some kernels 120 have user interfaces 318 that include context menus 306, so the teachings herein are not limited to applications 124 or to tools 122.

As indicated in FIG. 3, data 118 has at least three aspects which may be protected by proper use of teachings presented herein: confidentiality 320, integrity 322, and availability 324. A given context menu item operation 304 may threaten any one or more of these data aspects, so a given context menu policy 206 may specify enforcement designed to mitigate risk to any one or more of these data aspects.

Although the teachings provided herein may be used to protect any kind of data 118, in practice most environments distinguish between data generally (which is presumed to be non-sensitive) and sensitive data 326. Sensitive data 326 may be designated as such by labels, by metadata, by naming conventions, by a date or a date range or a timestamp or a timestamp range, or by location within designated storage for sensitive data, for example. The criteria for designating data as sensitive may vary between embodiments, as such criteria are orthogonal to the teachings provided herein for protecting data which is designated as sensitive. That is, the teachings are broadly applicable to protection of sensitive data 326 regardless of the criteria under which that data was designated as sensitive, and regardless of who designated it as sensitive.

Machines or processes within an enhanced system 202 may be networked generally or communicate in particular (via network or otherwise) with one another and with external devices (e.g., public search engines, public translation engines) through one or more interfaces 330. An interface 330 may include hardware such as network interface cards, software such as network stacks, APIs, or sockets, combination items such as network connections, or a combination thereof.

An enhanced system 202 will generally provide better security risk monitoring and mitigation than a system 102 that lacks context menu policy enforcement functionality 204, when each system is configured with the same or similar sensitive data 326, and with otherwise similar or identical applications 124 and kernels 120, and is subjected to user interaction with users 104 who have the same or similar levels of security training and job descriptions. These advantages in system security will be gained because the enhanced system 202 will perform context menu operation 304 monitoring and risk mitigation, as taught herein, that the non-enhanced system does not perform.

Moreover, security advantages may be gained without undue burdens on usability, because the enforcement functionality 204 can be tightly integrated with application 124 business logic or user interface capabilities so the user's attention is not abruptly interrupted by security queries from the functionality 204. In addition, it is contemplated that in most if not all embodiments the user will not face security configuration choices such as those sometimes requested or required by other kinds of secured software, e.g., which encryption protocol to use, whether to pay a subscription fee for malware signature updates, or what digital certificate to use for authentication or authorization.

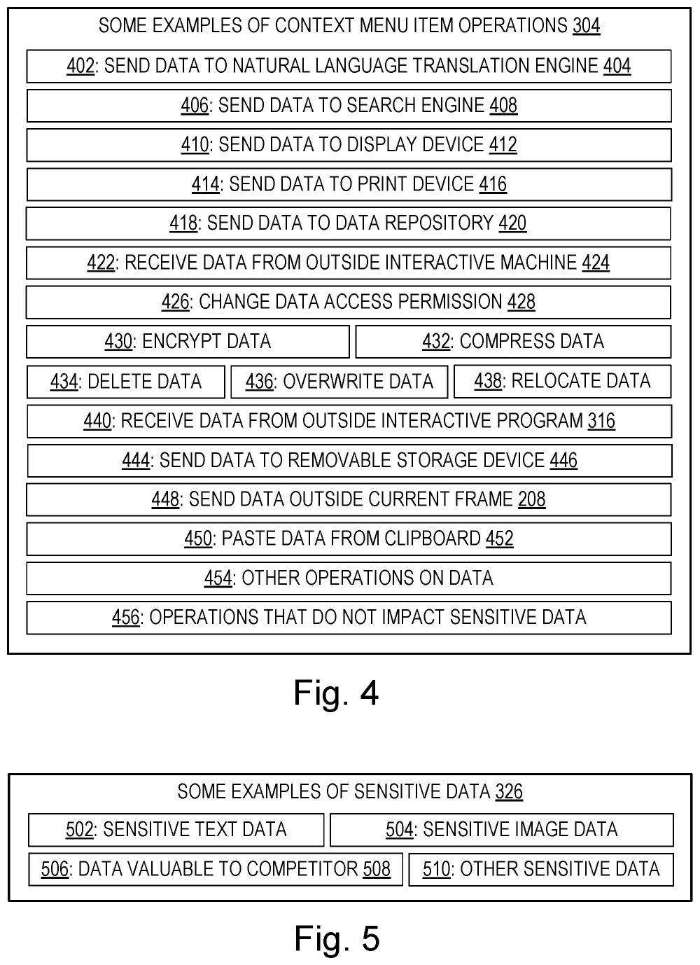

FIG. 4 illustrates several examples of context menu item operations 304. These items are discussed at various points herein, and additional details regarding them are provided in the discussion of a List of Reference Numerals later in this disclosure document.

FIG. 5 illustrates some examples of sensitive data 326. These items are discussed at various points herein, and additional details regarding them are provided in the discussion of a List of Reference Numerals later in this disclosure document.

Some embodiments use or provide a functionality-enhanced system, such as system 202 or another system 102 that is enhanced as taught herein. In some embodiments, a system 202 configured for context menu security policy enforcement includes a digital memory 112 containing sensitive data 326, and an interactive program 316. The interactive program 316 has a user interface 318 which includes a context menu 306 having at least one context menu item 302 that is configured to access the sensitive data 326. A processor 110 is in operable communication with the memory 112. The processor is configured, e.g., with software 208, 210, or 212, to perform context menu security policy enforcement steps which include (a) detecting 602 a triggering 604 of the context menu item, (b) sending 606 a policy query 308 which identifies the triggered context menu item, (c) receiving 614 a policy response 310 to the policy query, and (d) performing 618 a policy action 312 that is specified by the policy response, wherein performing the policy action includes vetting 620, modifying 622, or blocking 624 an operation of the context menu item, thereby protecting the sensitive data by maintaining 626 or enhancing 626 a confidentiality 320 of the sensitive data, an integrity 322 of the sensitive data, or an availability 324 of the sensitive data.

In some embodiments, the processor 110 is configured by at least one of the following to perform at least one of the context menu security policy enforcement steps: a monitor script 208, a monitor script 208 identification within a hypertext markup language document, an event listener 210.

In some embodiments, the context menu 306 resides on an interactive machine 424, and the system 202 further includes at least one of the following: a remote policy server 224 located on a server machine 102 which is not the interactive machine, and wherein the remote policy server is configured for networked communication with the interactive machine to receive 608 the policy query from the interactive machine and to send 612 the policy response to the interactive machine; a local policy cache 314 on the interactive machine, the local policy cache containing a policy action 312 or a policy response 310 received from a remote policy server which is located on a server machine which is not the interactive machine; or a local policy server 224 located on the interactive machine, and wherein the local policy server is configured to receive the policy query and to send the policy response.

Unless otherwise stated, a context menu item 302 subject to policy enforcement as taught herein may have any nominal capability designated by the author or vendor of the interactive program 316. That is, the teachings may be applied to all context menu items now known or hereafter created, unless a limitation to specific context menu items or operations is stated.

A context menu item operation 304 may be barred 806, 818, 848 from visibility, or modified 808, 828, 832 to prevent transmission of sensitive data, or modified to request 840 express informed user approval before sensitive data is transmitted, for example. Other policy 206 enforcement actions are also within the scope of teachings presented herein.

Some embodiments include or highlight or restrict enforcement to context menu items that do not necessarily involve a clipboard 452; in some cases, these context menu items also involve network transmission. In some embodiments, the context menu 306 resides on an interactive machine 424, and the context menu item includes or invokes context menu item code 332 that is configured to perform at least one of the following upon execution: an operation 406 to send data over a network to a search engine 408 that is located at least partially outside the interactive machine (e.g., search using a Google® or Bing® search engine, thus implicating a data confidentiality risk) (marks of Google, LLC and Microsoft Corporation, respectively); an operation 402 to send data over a network to a natural language translation engine 404 that is located at least partially outside the interactive machine (implicating a data confidentiality risk); an operation 410 to send data over a network to a display device 412 that is located at least partially outside the interactive machine (e.g., cast to device, a.k.a. play to device, implicating a data confidentiality risk); an operation 414 to send data over a network to a print device 416 that is located at least partially outside the interactive machine (implicating a data confidentiality risk); an operation 418 to send data over a network to a data repository 420 that is located at least partially outside the interactive machine (e.g., move to DropBox® location, implicating a data confidentiality risk) (mark of DropBox, Inc.); or an operation 440 to receive data onto the interactive machine through a network from a location outside the interactive machine (e.g., import, download, implicating a data integrity risk).

Some embodiments include or highlight or restrict enforcement to context menu items that involve data availability risk, or data integrity risk; in some cases, these context menu items also involve network transmission. In some embodiments, the context menu 306 resides on an interactive machine 424, and the context menu item includes or invokes context menu item code 332 that is configured to perform at least one of the following upon execution: an operation 426 to change a data access permission 428 (e.g., share, thus implicating a data confidentiality risk and a data availability risk); an operation 430 to encrypt data (e.g., zip with password or shred, implicating a data availability risk); an operation 432 to compress data (e.g., zip with or without password, implicating a data availability risk); an operation 434 to delete data (e.g., delete or remove, implicating a data availability risk); an operation 436 to overwrite data (e.g., save, restore from backup, implicating a data availability risk and a data integrity risk); an operation 438 to relocate data (e.g., move, save as, or defragment, implicating a data availability risk and a data integrity risk); an operation 440 to receive data from a location outside the interactive program (e.g., paste, import, download, implicating a data integrity risk); or an operation 422 to receive data onto the interactive machine through a network from a location outside the interactive machine (e.g., import or download, implicating a data integrity risk).

In some situations, the sensitive data 326 includes text. Thus, in some embodiments the sensitive data includes text data, and in some the interactive program is a browser which displays text data. Sensitive text 502 may be in any digital text format, e.g., HTML or .txt or .rtf or .docx file formats. The sensitive text's content may include, e.g., credit card or other account info, source code, confidential reports or analyses, medical information, or other sensitive content. Although sensitive text is given particular attention in some examples, the teachings presented herein may also be beneficially applied to protect other kinds of sensitive data, e.g., graphics files, computer aided design files, sound files, executables, and so on.

Other system embodiments are also described herein, either directly or derivable as system versions of described processes or configured media, duly informed by the extensive discussion herein of computing hardware. Examples are provided in this disclosure to help illustrate aspects of the technology, but the examples given within this document do not describe all of the possible embodiments. An embodiment may depart from the examples. For instance, items shown in different Figures may be included together in an embodiment, items shown in a Figure may be omitted, functionality shown in different items may be combined into fewer items or into a single item, items may be renamed, or items may be connected differently to one another. A given embodiment may include or utilize additional or different context menu items 302, policy actions 312, technical features, operational sequences, data structures, or policy 206 enforcement functionalities for instance, and may otherwise depart from the examples provided herein.

Processes (a.k.a. Methods)

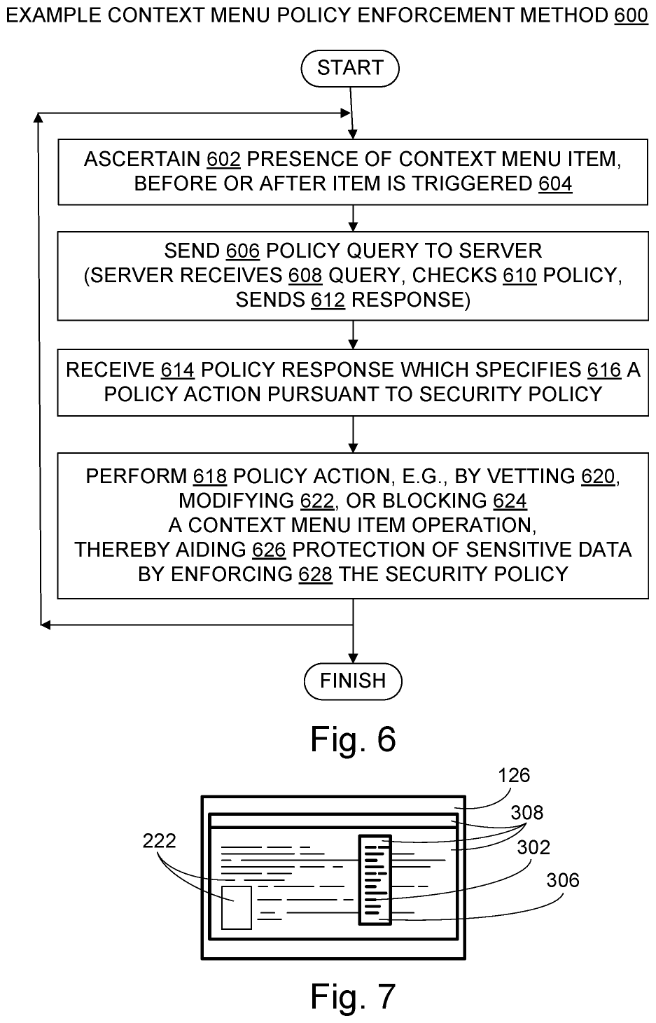

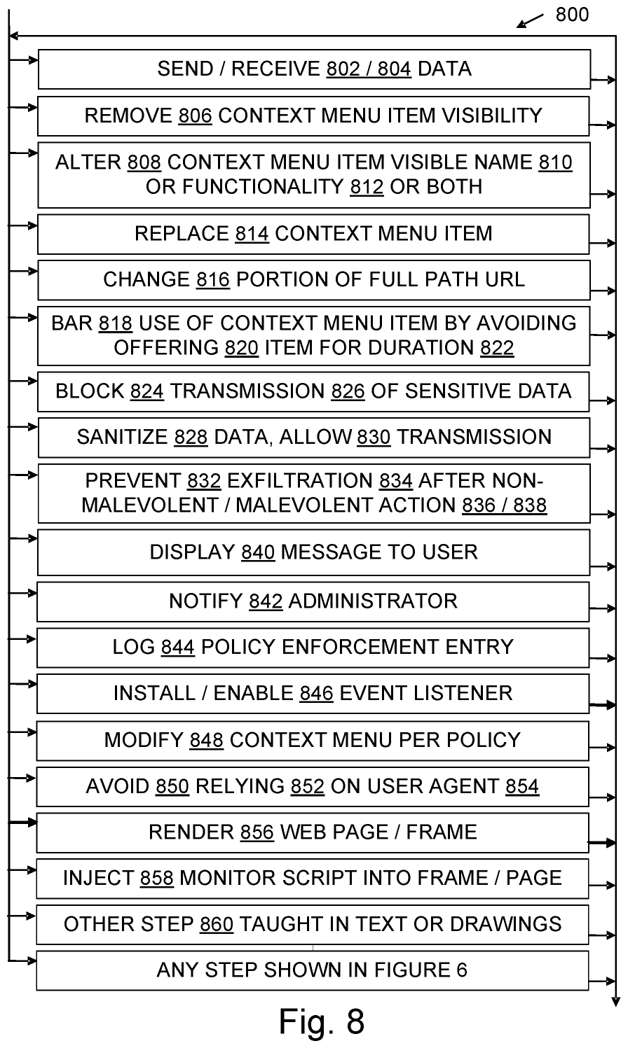

FIG. 6 illustrates a family of methods 600 that may be performed or assisted by a given enhanced system, such as any system 202 example herein or another functionality 204 enhanced system as taught herein. FIG. 8 further illustrates context menu policy enforcement methods. FIG. 8 incorporates all steps shown in FIG. 6. Methods 600 or 800 may also be referred to as context menu policy enforcement “processes” in the legal sense of the word “process”.

Technical processes shown in the Figures or otherwise disclosed will be performed automatically, e.g., by an enhanced system 202 or software component thereof, unless otherwise indicated. Processes may also be performed in part automatically and in part manually to the extent activity by a human person is implicated. For example, in some embodiments a human may respond to a warning displayed 840 by policy enforcement code by providing permission to transmit certain data, thereby allowing 830 transmission of that data. But no process contemplated as innovative herein is entirely manual.

In a given embodiment zero or more illustrated steps of a process may be repeated, perhaps with different parameters or data to operate on. Steps in an embodiment may also be done in a different order than the top-to-bottom order that is laid out in FIGS. 6 and 8. Steps may be performed serially, in a partially overlapping manner, or fully in parallel. In particular, the order in which flowchart 600 or flowchart 800 operation items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments use or provide a method for context menu security policy enforcement to aid protection of a sensitive data item, including automatically: ascertaining 602 a presence of a context menu item in an interactive program; proactively sending 606, to a policy server, a policy query which identifies the context menu item; receiving 614, from the policy server, a policy response to the policy query, the policy response specifying a policy action pursuant to a context menu item policy; and performing 618 the policy action by vetting 620, modifying 622, or blocking 624 an operation of the context menu item. In this manner, the method aids 626 protection of the sensitive data item by enforcing 628 a context menu security policy.

Some embodiments change a context menu so a risky menu item is not seen as much, or maybe not at all, by the user. In some embodiments performing 618 the policy action includes at least one of the following: removing 806 a context menu item from user visibility within the context menu; replacing 814 the context menu item with a replacement context menu item; altering 808 a visible name of the context menu item or a functionality of the context menu item, or both; or barring 818 use of the context menu item in the context menu, thereby avoiding offering the context menu item to users within the context menu during an effective duration of the context menu item policy.

Some policy actions change URLs. As used here, change to a “full path uniform resource locator” encompasses changes to a domain (e.g., a suffix change) or changes to query path parameters or both. In some embodiments, performing 618 the policy action includes changing 816 at least a portion of a full path uniform resource locator.

Some embodiments provide ways to protect confidentiality 320. In some embodiments, performing 618 the policy action includes at least one of the following: blocking 824 network transmission of at least a portion of the sensitive data; or sanitizing 828 at least a portion of the sensitive data and then allowing network transmission of the sanitized data.

Some embodiments also perform at least one of the following: displaying 840 a message to a user of the interactive program indicating the performance of the policy action; notifying 842 an administrator of the policy response; or logging 844 at least one of: the policy query, the policy response, or the policy action.

Some embodiments use a context menu event listener 210. This could be a listener for the context menu as a whole, or a listener focused on one or more particular context menu items. In some embodiments, the method includes installing 846 or enabling 846 a software listener for at least one of the following: triggering 604 of the context menu item; or triggering 604 of the context menu regardless of which context menu item, if any, is also triggered.

Some embodiments include, or focus on, context menu items that often or always involve the clipboard 452. In some embodiments, the context menu item includes or invokes context menu item code 332 that is configured to perform at least one of the following upon execution: an operation 444 to send data to a removable storage device (e.g., copy folder to flash drive, DVD, etc., implicating a data confidentiality risk); an operation 448 to send data outside a current frame of a web browser (e.g., copy from current tab to another program or the local drive, implicating a data confidentiality risk); or an operation 450 to paste data from a clipboard to a location outside the interactive program (e.g., control-v, paste, paste as plain text—even on the same machine, implicating a data confidentiality risk).

Some embodiments dynamically modify the context menu seen by the user, based on policy 206 governing context menu items 302 and whether the accessible data is sensitive 326. In some embodiments, the method includes automatically and proactively modifying 848 the context menu during execution of the interactive program, the modifying based on a context menu policy, such that a first context menu version is displayed for use with sensitive data and a second and different context menu version is displayed for use with non-sensitive data.

Some embodiments use a cloud security broker 216 or another proxy 218. In some, sending 606 the policy query sends the policy query to at least one of the following: a cloud security broker, or a proxy.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as policies 206, policy queries 308, policy responses 310, policy actions 312, monitor code 208, listener code 210, and enforcer code 212, in the form of data 118 and instructions 116, read from a removable storage medium 114 and/or another source such as a network connection, to form a configured storage medium. The configured storage medium 112 is capable of causing a computer system 102 to perform technical process steps for context menu security policy enforcement, as disclosed herein. The Figures thus help illustrate configured storage media embodiments and process (a.k.a. method) embodiments, as well as system and process embodiments. In particular, any of the process steps illustrated in FIG. 6 or 8 or otherwise taught herein, may be used to help configure a storage medium to form a configured storage medium embodiment.

Some embodiments use or provide a computer-readable storage medium 112, 114 configured with data 118 and instructions 116 which upon execution by at least one processor 110 cause a computing system to perform a method for context menu security policy enforcement to aid protection of a sensitive data item. This method includes: ascertaining 602 a presence of a context menu item in an interactive web browser program; proactively sending 606, to a policy server, a policy query which identifies the context menu item; receiving 614, from the policy server, a policy response to the policy query, the policy response specifying a policy action; and performing 618 the policy action by vetting, modifying, or blocking an operation of the context menu item in the web browser, whereby the method aids protection of the sensitive data by enforcing a context menu security policy.

In some embodiments, the context menu resides on an interactive machine, and the context menu item includes or invokes context menu item codes that are configured to respectively perform at least N of the following upon execution, where N is one, two, three, four, five, six, seven, eight, nine, ten, eleven, or twelve, depending on the embodiment: an operation 406 to send data over a network to a search engine that is located at least partially outside the interactive machine; an operation 402 to send data over a network to a natural language translation engine that is located at least partially outside the interactive machine; an operation 410 to send data over a network to a display device that is located at least partially outside the interactive machine; an operation 414 to send data over a network to a print device that is located at least partially outside the interactive machine; an operation 418 to send data over a network to a data repository that is located at least partially outside the interactive machine; an operation 444 to send data to a removable storage device; an operation 448 to send data outside a current frame of a web browser; an operation 450 to paste data from a clipboard to a location outside the interactive program; an operation 426 to change a data access permission; an operation 430 to encrypt data; an operation 432 to compress data; an operation 434 to delete data; an operation 436 to overwrite data; an operation 438 to relocate data; or an operation 422 to receive data onto the interactive machine from a location outside the interactive machine.

In some embodiments, the method is performed without relying on any user agent to send the policy query or receive the policy response or perform the policy action. In some, no policy-enforcement-specific digital certificate is required.

In some embodiments, the method aids protection of the sensitive data by enforcing a context menu security policy in at least one of the following scenarios: the method prevents exfiltration of the sensitive data after a non-malevolent invocation of a context menu item operation (e.g., an innocent mistake), or the method prevents exfiltration of the sensitive data after an invocation of a context menu item operation by an action from a recognized user which is outside the scope of their authority (e.g., an attempt to copy data without permission prior to leaving the company).

In some embodiments, context menu policy enforcement is part of browser rendering. For instance, in some the context menu item presence ascertaining 602, the policy query sending 606, the policy response receiving 614, and the policy action performing 618 each occur during a page rendering 856 within the web browser.

Technical Character

The technical character of embodiments described herein will be apparent to one of ordinary skill in the art, and will also be apparent in several ways to a wide range of attentive readers. Some embodiments address technical activities such as monitoring the presence or activation of context menu items, automatically and proactively querying a security policy server, injecting monitor scripts into web pages, and reducing or preventing exfiltration of sensitive data over a computer network, each of which is an activity deeply rooted in computing technology. Some of the technical mechanisms discussed include, e.g., security proxies 218, scripts, event listeners 210, context menus 306, and context menu item operations codes 332. Some of the technical effects discussed include, e.g., enhanced protection of sensitive data 326 against confidentiality, integrity, or availability risks from the operation of context menus, and automatic creation of digital audit logs of context menu activity. Thus, purely mental processes are clearly excluded. Other advantages based on the technical characteristics of the teachings will also be apparent to one of skill from the description provided.

Additional Examples and Observations

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, some additional examples and observations are offered.

Some embodiments provide functionality 204 that is focused on monitoring one or more browser context menu data extraction features 332. By way of context, a proxy policy system 202 may be designed and configured to offer its customers a way to monitor every method of exporting (a.k.a., extracting or exfiltrating) sensitive data 326 from web pages 232 across all browsers 226. Part of this effort includes monitoring file downloads, monitoring page prints, and monitoring browser context menu features that search focused or selected text of the page using search engines outside the browser. Such a search feature 332 may export sensitive content from an application (e.g., browser) that is monitored.

Some embodiments detect a browser's specific context menu (e.g., so-called “right click”) feature and inspect the feature's activity in view of one or more security policies. Some embodiments either block export activity, or replace the sensitive content (or any potentially sensitive content) with an empty predefined content 118.

As an example, assume the string “Sensitive data” is highlighted in a document, and an activated context menu displays the following items:

### Cut Ctrl+X

### Copy Ctrl+C

### Paste Ctrl+V

### Paste Text Only Ctrl+Shft+V

Search “Sensitive data”

### Translate

### Set Proofing Language . . .

### Rewrite Suggestions

### Paragraph . . .

### Link . . .

### New Follow-up

### New Comment

With the benefit of insights from the present disclosure, one may view these context menu items not merely from the perspective of an application user, but also from the perspective of a cybersecurity innovator now apprised of new functionality that may (and in fact often does) carry with it some new risks. Any context menu item 302 that can send data 118 outside a specified security boundary, or receive data from outside the security boundary, carries a risk to sensitive data 326 that would otherwise be safe from that risk. The security boundary may be defined by the extent of a current browser tab, a current opened page or other document, a current interactive application, or a current interactive machine, for example, in a given embodiment.

In particular, the “search for” context menu feature is a recent addition in all major browsers. Upon consideration of this feature, the innovators devised an innovative way to gain actionable visibility to internal digital state in situations such as one in which a user right clicks on focused text to search for sensitive data outside the application; the innovators realized this search could lead to sensitive data being extracted outside the monitored session. To address that risk, some embodiments enforce policies 206 on data being shown in a context menu “search for” browser feature. In particular, in some embodiments policy 206 enforcement involves using a cloud app security proxy-based control, as part of a more complete solution to control any input or output going into or out of a web application. This may be part of offering a “read only mode” to applications.

The innovators also extended this policy enforcement to other context menu items 302 and their corresponding feature codes. Paste operations 304, translate operations 304, and operations 304 that obtain rewrite suggestions, for instance, may each cross a browser tab or other security boundary. Paste carries a copy of data to a new location and inserts the copy there; this poses a risk when the insertion location is past the security boundary. Search, translate, rewrite, and get-synonyms operations each send a copy of data to a specialized engine as input in order to receive a corresponding output from that engine; since the specialized engine is generally outside the security boundary, sending data to the engine carries a risk.

Some embodiments described herein may be viewed by some people in a broader context. For instance, concepts such as availability, confidentiality, integrity, interaction, security, or visibility may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to reduce or avoid risks to sensitive data in software that supports context menu operations. Other configured storage media, systems, and processes involving availability, confidentiality, integrity, interaction, security, or visibility are outside the present scope. Accordingly, vagueness, mere abstractness, lack of technical character, and accompanying proof problems are also avoided under a proper understanding of the present disclosure.

Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples and scenarios, operating environments, context menu item examples, sensitive data examples, exfiltration and infiltration examples, software processes, identifiers, data structures, data formats, notations, control flows, naming conventions, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GDPR: General Data Protection Regulation

GPU: graphical processing unit

GUI: graphical user interface

IaaS or IAAS: infrastructure-as-a-service

ID: identification or identity

IP: internet protocol

LAN: local area network

OS: operating system

PaaS or PAAS: platform-as-a-service

RAM: random access memory

ROM: read only memory

TCP: transmission control protocol

TPU: tensor processing unit

UEFI: Unified Extensible Firmware Interface

URL: uniform resource locator

WAN: wide area network

Note Regarding Hyperlinks

Portions of this disclosure contain URLs, hyperlinks, IP addresses, and/or other items which might be considered browser-executable codes. These items are included in the disclosure for their own sake to help describe some embodiments, rather than being included to reference the contents of the web sites or files that they identify. Applicants do not intend to have these URLs, hyperlinks, IP addresses, or other such codes be active links. None of these items are intended to serve as an incorporation by reference of material that is located outside this disclosure document. Thus, there should be no objection to the inclusion of these items herein. To the extent these items are not already disabled, it is presumed the Patent Office will disable them (render them inactive as links) when preparing this document's text to be loaded onto its official web database. See, e.g., United States Patent and Trademark Manual of Patent Examining Procedure § 608.01(VII).

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. Security proxies may be implemented with services or accessed via services, for example.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write).

“Access” to a computational resource includes use of a permission or other capability to read, modify, write, execute, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Context menu policy enforcement operations such as sending 606 policy queries, receiving 614 policy responses, removing 806 context menu item visibility, changing 816 URLs to indicate a protected environment, blocking 824 data transmission, logging 844 policy enforcement activity, installing 846 event listeners, and many other operations discussed herein, are understood to be inherently digital. A human mind cannot interface directly with a CPU or other processor, or with RAM or other digital storage, to read and write the necessary data to perform the context menu policy enforcement steps taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general purpose processor which executes it, thereby transforming it from a general purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as aiding, allowing, altering, ascertaining, barring, blocking, changing, checking, displaying, enforcing, injecting, installing, logging, modifying, notifying, offering, performing, preventing, receiving, relying, rendering, replacing, sanitizing, sending, triggering, vetting (and aids, aided, allows, allowed, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:

100 operating environment, also referred to as computing environment

102 computer system, also referred to as a “computational system” or “computing system”, and when in a network may be referred to as a “node”

104 users, e.g., an analyst or other user of an enhanced system 202

106 peripherals

108 network generally, including, e.g., clouds, local area networks (LANs), wide area networks (WANs), client-server networks, or networks which have at least one trust domain enforced by a domain controller, and other wired or wireless networks; these network categories may overlap, e.g., a LAN may have a domain controller and also operate as a client-server network

110 processor

112 computer-readable storage medium, e.g., RAM, hard disks

114 removable configured computer-readable storage medium

116 instructions executable with processor; may be on removable storage media or in other memory (volatile or non-volatile or both)

118 data

120 kernel(s), e.g., operating system(s), BIOS, UEFI, device drivers

122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, browsers, and so on

124 applications, e.g., word processors, web browsers, spreadsheets, games, email tools, commands

126 display screens, also referred to as “displays”

128 computing hardware not otherwise associated with a reference number 106, 108, 110, 112, 114

202 enhanced computing system, e.g., one or more computers 102 enhanced with context menu policy enforcement functionality, or computers which perform a method 600 or 800

204 context menu policy enforcement functionality, e.g., functionality which does at least one of the following: ascertains the presence of sensitive data which is subject to a context menu security policy 206, ascertains the presence of a context menu which is subject to a context menu security policy 206, ascertains the presence of a context menu item which is subject to a context menu security policy 206, installs or enables or relies upon context menu monitor code 208 or context menu listen code 210 or context menu enforce code 212, functions as a context menu policy server, conforms with the FIG. 8 flowchart or its constituent flowchart 600, or otherwise provides capabilities first taught herein

206 context menu security policy, namely, a policy which addresses one or more risks to sensitive data confidentiality or integrity or availability specifically with regard to one or more context menu items; understood to be or include a digital data structure that is integrated functionally into a system 202 as opposed to being merely human-readable printed matter

208 context menu monitor code, e.g., a script or other software that upon running monitors the presence or activation of a context menu or a context menu item, or modifies the appearance or behavior of a context menu or a context menu item, or a combination thereof, thereby aiding enforcement of a context menu security policy 206

210 context menu listen code, e.g., a script or other software that upon running installs or enables an event listener which operates as context menu monitor code

212 context menu enforce code, e.g., a script or other software that upon running modifies the appearance or behavior of a context menu or a context menu item, thereby aiding enforcement of a context menu security policy 206

214 frame, e.g., web page frame

216 security broker, e.g., cloud access security broker

218 security proxy, e.g., security broker or other security software positioned as a proxy between a user and a web server

220 HTML or other code of a web page exclusive of the codes 208, 210, 212

222 HTML, scripts, images, and other content of a web page exclusive of the codes 208, 210, 212

224 policy server, e.g., software which receives a policy information request from a requestor, checks a security policy that matches the request information to a policy enforcement action, and sends the requestor a response that identifies the policy enforcement action; e.g., a request may ask what action to take if a context menu translate option is detected, whereon the policy server may respond that the context menu translate option should not be displayed whenever the currently open document is labeled as being sensitive data

226 web browser

228 protected environment, e.g., a digital environment in which a particular set of security policies is enforced

230 uniform resource locator (URL); for context menu policy enforcement purposes, URLs and uniform resource identifiers (URIs) may be treated the same as one another

232 web page

234 web server

300 aspects of systems 202 or environments 228 or both

302 context menu item; in usage the phrase “context menu item” may refer to a displayed name 810 such as “search” or “translate” or “Ctrl-V”, or to a data structure representing the name and associated code 332, or to code 332 that implements the named operation 304, or to the corresponding operation, e.g., a web search operation or an operation which attempts automated translation from English to Hebrew, and so on; a context menu item may also be referred to as a “menu item” or a “context menu feature” or a “context menu option”, for example

304 context menu item operation; may also be referred to as a “context menu operation”; performed computationally by a system 202

306 context menu; in usage the phrase “context menu” may refer to a displayed context menu of items 302, or to a data structure representing the displayed context menu or a data structure representing the available but not necessarily fully displayed context menu, or to code that implements the context menu item's display operation 304, for example

308 policy query; in usage may refer to a data structure representing a query about a policy 206 or to a digital transmission of such a data structure

310 policy response; in usage may refer to a data structure representing a response to a policy query or to a digital transmission of such a data structure

312 policy action; in usage may refer to a data structure representing an action suggested by or mandated by a policy 206 or to performance of such a computational action by a system 202

314 cache in a digital memory, organized by containing one or more instances of a policy query, a policy response, or a policy action

316 interactive program, e.g., an application 124, tool 122, kernel 120, or other software which interacts with a human user or is configured for such interaction

318 user interface; most likely a graphical user interface in a program 316, but a text interface such as a command line interface could also present context menus and enforce context menu security policy as taught herein

320 data confidentiality; violated, e.g., when data becomes known to someone who, according to a security policy, should not have known the data

322 data integrity; violated, e.g., when data becomes changed through tampering by someone who, according to a security policy, should not have changed the data in that manner

324 data availability; violated, e.g., when data becomes inaccessible to someone who, according to a security policy, should be able to access the data;

destroying data makes the data inaccessible if no copy is available

326 sensitive digital data

328 log, audit trail, or other record of activities or data values or both

330 interface generally

402 context menu operation which sends digital data to a natural language translation engine

404 natural language translation engine, e.g., software or hardware engine which performs machine translation between natural languages (as opposed to computer programming languages)

406 context menu operation which sends data to a search engine, e.g., a web search engine or a database user interface

408 search engine, e.g., software or hardware engine which searches the web (a.k.a. Internet for present purposes), a document collection, database, or other set of digital information

410 context menu operation which sends data to a display device

412 display device, e.g., screen, television, projector, or other device that makes digital images visible

414 context menu operation which sends data to a print device

416 print device, e.g., laser printer, dot matrix printer, 3D printer, or other device, powered by electricity, that creates a tangible representation of digital information that persists after the print device no longer has electric power

418 context menu operation which sends data to a data repository

420 data repository, e.g., source code repository, shared filesystem, database, archive, or other collection of digital data that is accessible to multiple people

422 context menu operation which receives digital data from outside an interactive machine

424 physical or virtual machine running an interactive program 316

426 context menu operation which changes an access permission

428 access permission, e.g., access control list, access token, digital certificate, group membership, or other mechanism which guides or controls access to a digital resource; may implicate authentication or authorization or both

430 context menu operation which encrypts data

432 context menu operation which compresses data

434 context menu operation which deletes at least one copy of data

436 context menu operation which overwrites data

438 context menu operation which moves data from one physical or virtual location to a different location, e.g., a different drive, different directory, renamed file, different URL, etc.

440 context menu operation which receives digital data from outside an interactive program

444 context menu operation which sends data to a removable storage device

446 removable storage device, e.g., USB flash drive, DVD, CD, memory stick, external hard drive, optical disk, camera, medium 114 device, etc.

448 context menu operation which sends data from inside a current frame to outside the current frame

450 context menu operation which pastes (insert or overwrite) data from a clipboard

452 clipboard, e.g., a user-accessible temporary data storage location in volatile memory; generally operates as a single entry stack with copy (push) and paste (pop) operators

454 any context menu operation not otherwise designated

456 any context menu operation that does not directly impact sensitive data; in a given environment, this could be, e.g., an operation set the proofing language in a word processor, change margins, change font or font size in a display, display the full URL of the current document, and so on

502 sensitive data which consists of, or includes, text in a natural language or a programming language or natural language alphabet; emojis, ideograms, and any character in any publicly available font is considered text

504 sensitive data which consists of or includes an image; may be pixels or vector graphic format or other data formats, and may include or depict text

506 data which is valuable to a competitor, e.g., any trade secret data

508 competitor, e.g., any business entity, government agency, or political entity other than X may be considered a competitor of X

510 any sensitive data not otherwise designated

600 flowchart; 600 also refers to context menu policy enforcement methods illustrated by or consistent with the FIG. 6 flowchart

602 ascertain the presence in an interactive program code or an interactive program usage session, of a context menu or context menu item; performed computationally by a system 202

604 trigger a context menu or context menu item, e.g., by recognizing it is selected or activated due to an interactive gesture or selection or choice or command entered by a user

606 send a policy query to a policy server; performed computationally, e.g., using procedure calls, network packets, or other computational mechanisms

608 receive a policy query; performed computationally

610 check a policy 206 in response to receipt of a policy query;
performed computationally, e.g., using parsing, table look-up, database query, file reads, or other computational mechanisms

612 send a policy response from a policy server; performed using procedure calls, network packets, or other computational mechanisms

614 receive a policy response; performed computationally

616 specify a policy action, e.g., by including a description or identification of the policy action within a policy response data structure

618 computationally perform a policy action

620 vet a context menu operation, e.g., by computationally confirming that the user who ordered the operation has authority to do so, e.g., code 332 running on behalf of an admin user may be allowed to perform a search operation 304 that would be denied permission if initiated by a non-admin user

622 modify a context menu operation, e.g., by adding a test for sensitive data and allowing only limited operation when sensitive data is involved, or by computationally performing any of the steps herein having reference numeral 806, 808, 814, 816, 818, 824, 828, 832, 846, 848, or 858

624 block a context menu operation, e.g., by computationally performing any of the steps herein having reference numeral 824, 828, or 832

626 computationally aid protection of sensitive, e.g., by performing any of the steps herein having reference numeral 618, 620, 622, or 624 on sensitive data 326

628 computationally enforce a security policy 206 by performing any of the steps herein having reference numeral 602, 606, 614, 618, or 626 specifically with respect to a context menu or context menu item

800 flowchart; 800 also refers to context menu policy enforcement methods illustrated by or consistent with the FIG. 8 flowchart (which incorporates the steps of FIG. 6)

802 computationally send data; data herein us presumed to be digital data whether expressly stated so in a given instance or not

804 computationally receive data

806 computationally remove context menu item visibility, e.g., by graying out the menu item's name or by removing it completely from what is displayed to the user

808 computationally alter context menu item, e.g., from “paste” to “paste within document”, or from “search” to “search locally”

810 context menu item visible name, e.g., “search”, “translate”, and so on from the context menu examples herein (these are nonlimiting examples)

812 context menu item functionality, as implemented by context menu item code 332, e.g., search functionality, cut or paste functionality, etc.

814 computationally replace context menu item, e.g., alter 808 both name and functionality

816 computationally change portion of a full path URL, e.g., by adding a domain suffix

818 computationally bar use of context menu item, e.g., by removing 806 the menu item before the context menu has been displayed in the current interactive program session, and by avoiding offering 820 (displaying) the context menu item during the session 822

824 computationally block transmission of sensitive data, e.g., by not transmitting any data during a context menu item operation or by transmitting only sanitized data during the context menu item operation

826 transmit sensitive data over a network connection, e.g., using TCP/IP or UDP

828 sanitize a copy of data, e.g., by overwriting sensitive portions of the data (e.g., 800-555-9999->xxx-xxx-xx99), or by removing sensitive portions (e.g., Name: Pat Doe, SSN: , Member: Y) or by replacing sensitive portions with predetermined non-sensitive content (e.g., Name: Pat Doe, SSN: private, Member: Y)

830 allow data transmission, e.g., after vetting 620 or sanitizing 828

832 computationally prevent data exfiltration, e.g., by blocking 824 or sanitizing 828

834 data exfiltration, e.g., sending data out across a security boundary

836 non-malevolent action, e.g., an innocent mistake not intended to violate any regulation, law, or company rule or policy

838 malevolent action, e.g., an action suspected by or known by the actor to be a violation of some regulation, law, or company rule or policy

840 display a message on a screen 126

842 notify an administrator, e.g., by alert, text, email, or other computational mechanism

844 enter information in a log 328

846 computationally install or enable an event listener

848 modify a context menu per a policy 206, e.g., by removing 806 an item 302 from the context menu, or by not showing the menu at all

850 avoid relying on a user agent, e.g., by relying instead on an injected script

852 rely on a user agent to monitor activity within a program

854 user agent, e.g., a separate task or process than a program, which monitors activity by the program

856 computationally render (draw) a web page on a screen

858 computationally inject a script into web page content, e.g., a a proxy before forwarding the modified web page to a user's browser

860 any step discussed in the present disclosure that has not been assigned some other reference numeral

### CONCLUSION

In short, the teachings herein provide a variety of context menu security policy enforcement functionalities 204 which operate in enhanced systems 202. Embodiments address context menu item 302 operations 304 which pose risks to sensitive data 326, such as confidentiality 320 violations from data exfiltration during “search” or “translate” communications 304 with external sites, as well as “paste”, “delete”, “move” and other context menu item operations 304 that may harm data integrity 322 or data availability 324 even if no external site is involved. Control scripts 208 injected by a security broker 216 or proxy 218, working with event listeners 210 in a web page 232, may be used to monitor and control 808 web browser 226 context menu item 302 displays 810 and functionalities 812 based on suggested or mandated context menu policy actions 312 obtained 614 from a policy server 224. Policy 206 that is specific to context menus 306 is also enforced 628 in other interactive programs 316 that use context menus 306, thereby protecting 626 sensitive data 326 against both malevolent efforts 838 and innocent mistakes 836. Protection 626 may be provided for any kind of sensitive data 326, regardless of the sensitivity designation criteria or mechanism.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 6 and 8 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds or ranges, specific architectures, specific attributes, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system configured for context menu security policy enforcement, the system comprising:
a digital memory containing sensitive data;
an interactive program having a user interface which includes a context menu having at least one context menu item that is configured to access the sensitive data; and
a processor in operable communication with the digital memory, the processor configured to perform context menu security policy enforcement steps which include (a) detecting a triggering of the context menu item, (b) sending a policy query which identifies the triggered context menu item, (c) receiving a policy response to the policy query, and (d) performing a policy action that is specified by the policy response, thereby protecting the sensitive data by maintaining or enhancing a confidentiality of the sensitive data, an integrity of the sensitive data, or an availability of the sensitive data.

2. The system of claim 1, wherein the processor is configured by at least one of the following to perform at least one of the context menu security policy enforcement steps:
a monitor script;
a monitor script identification within a hypertext markup language document; or
an event listener.

3. The system of claim 1, wherein the context menu resides on an interactive machine, and the system further comprises at least one of the following:
a remote policy server located on a server machine which is not the interactive machine, and wherein the remote policy server is configured for networked communication with the interactive machine to receive the policy query from the interactive machine and to send the policy response to the interactive machine;
a local policy cache on the interactive machine, the local policy cache containing a policy action or a policy response received from a remote policy server which is located on a server machine which is not the interactive machine; or
a local policy server located on the interactive machine, and wherein the local policy server is configured to receive the policy query and to send the policy response.

4. The system of claim 1, wherein the context menu resides on an interactive machine, and wherein the context menu item includes or invokes context menu item code that is configured to perform at least one of the following upon execution:
an operation to send data over a network to a search engine that is located at least partially outside the interactive machine;
an operation to send data over a network to a natural language translation engine that is located at least partially outside the interactive machine;
an operation to send data over a network to a display device that is located at least partially outside the interactive machine;
an operation to send data over a network to a print device that is located at least partially outside the interactive machine;
an operation to send data over a network to a data repository that is located at least partially outside the interactive machine; or
an operation to receive data onto the interactive machine through a network from a location outside the interactive machine.

5. The system of claim 1, wherein the context menu resides on an interactive machine, and wherein the context menu item includes or invokes context menu item code that is configured to perform at least one of the following upon execution:
an operation to change a data access permission;
an operation to encrypt data;
an operation to compress data;
an operation to delete data;
an operation to overwrite data;
an operation to relocate data;
an operation to receive data from a location outside the interactive program; or
an operation to receive data onto the interactive machine through a network from a location outside the interactive machine.

6. The system of claim 1, further characterized in at least one of the following ways:
the sensitive data includes text data; or
the interactive program includes a web browser.

7. A method for context menu security policy enforcement to aid protection of a sensitive data item, the method comprising automatically:
ascertaining a presence of a context menu item in an interactive program;
proactively sending, to a policy server, a policy query which identifies the context menu item;
receiving, from the policy server, a policy response to the policy query, the policy response specifying a policy action pursuant to a context menu item policy; and
performing the policy action by vetting, modifying, or blocking an operation of the context menu item;
whereby the method aids protection of the sensitive data item by enforcing a context menu security policy.

8. The method of claim 7, wherein performing the policy action includes at least one of the following:
removing the context menu item from user visibility within the context menu;
replacing the context menu item with a replacement context menu item;
altering a visible name of the context menu item or a functionality of the context menu item, or both; or
barring use of the context menu item in the context menu, thereby avoiding offering the context menu item to users within the context menu during an effective duration of the context menu item policy.

9. The method of claim 7, wherein performing the policy action includes changing at least a portion of a full path uniform resource locator.

10. The method of claim 7, wherein performing the policy action includes at least one of the following:
blocking network transmission of at least a portion of the sensitive data; or
sanitizing at least a portion of the sensitive data and then allowing network transmission of the sanitized data.

11. The method of claim 7, further comprising at least one of the following:
displaying a message to a user of the interactive program indicating the performance of the policy action;
notifying an administrator of the policy response; or
logging at least one of: the policy query, the policy response, or the policy action.

12. The method of claim 7, further comprising installing or enabling a software listener for at least one of the following:
triggering of the context menu item; or
triggering of the context menu regardless of which context menu item, if any, is also triggered.

13. The method of claim 7, wherein the context menu item includes or invokes context menu item code that is configured to perform at least one of the following upon execution:
an operation to send data to a removable storage device;
an operation to send data outside a current frame of a web browser; or
an operation to paste data from a clipboard to a location outside the interactive program.

14. The method of claim 7, comprising automatically and proactively modifying the context menu during execution of the interactive program, the modifying based on a context menu policy, such that a first context menu version is displayed for use with sensitive data and a second and different context menu version is displayed for use with non-sensitive data.

15. The method of claim 7, wherein sending the policy query sends the policy query to at least one of the following:
a cloud security broker; or
a proxy.

16. A computer-readable storage medium configured with data and instructions which upon execution by a processor cause a computing system to perform a method for context menu security policy enforcement to aid protection of a sensitive data item, the method comprising automatically:
ascertaining a presence of a context menu item in an interactive web browser program;
proactively sending, to a policy server, a policy query which identifies the context menu item;
receiving, from the policy server, a policy response to the policy query, the policy response specifying a policy action; and
performing the policy action by vetting, modifying, or blocking an operation of the context menu item in the web browser;
whereby the method aids protection of the sensitive data by enforcing a context menu security policy.

17. The computer-readable storage medium of claim 16, wherein the context menu resides on an interactive machine, and wherein the context menu item includes or invokes context menu item codes that are configured to respectively perform at least three of the following upon execution:
an operation to send data over a network to a search engine that is located at least partially outside the interactive machine;
an operation to send data over a network to a natural language translation engine that is located at least partially outside the interactive machine;
an operation to send data over a network to a display device that is located at least partially outside the interactive machine;
an operation to send data over a network to a print device that is located at least partially outside the interactive machine;
an operation to send data over a network to a data repository that is located at least partially outside the interactive machine;
an operation to send data to a removable storage device;
an operation to send data outside a current frame of a web browser;
an operation to paste data from a clipboard to a location outside the interactive program;
an operation to change a data access permission;
an operation to encrypt data;
an operation to compress data;
an operation to delete data;
an operation to overwrite data;
an operation to relocate data; or
an operation to receive data onto the interactive machine from a location outside the interactive machine.

18. The computer-readable storage medium of claim 16, wherein the method is performed without relying on any user agent to send the policy query or receive the policy response or perform the policy action.

19. The computer-readable storage medium of claim 16, wherein the method aids protection of the sensitive data by enforcing a context menu security policy in at least one of the following scenarios:
the method prevents exfiltration of the sensitive data after a non-malevolent invocation of a context menu item operation; or
the method prevents exfiltration of the sensitive data after an invocation of a context menu item operation by an action from a recognized user which is outside the scope of their authority.

20. The computer-readable storage medium of claim 16, wherein the context menu item presence ascertaining, the policy query sending, the policy response receiving, and the policy action performing each occur during a page rendering within the web browser.
